(19) United States
(12) Patent Application Publication
(10) Pub. No.: US 2011/0139469 A1
(43) Pub. Date: Jun. 16, 2011

(54) DEVICE, SYSTEM, AND METHOD OF FIRE SUPPRESSION

(75) Inventors: Brian R. Garrett, Muncie, IN (US); Adam J. Hunt, Greenfield, IN (US)

(73) Assignee: EnerDel, Inc., Indianapolis, IN (US)

(21) Appl. No.: 12/638,148

(22) Filed: Dec. 15, 2009

(51) Int. Cl. A62C 3/07

(52) U.S. Cl. 169/46; 169/62

(57) ABSTRACT

The present application includes disclosure of various embodiments of a dip tube device, included in fire suppression devices and systems, and methods of using the same. In an exemplary embodiment, the dip tube is comprised of a first cylinder defining a first lumen having a first diameter, a second cylinder defining a second lumen having a second diameter, and a joining member operably connecting the first lumen with the second lumen to allow a substance to pass therethrough, the joining member allowing movement of the second cylinder relative to the first cylinder. In an exemplary embodiment, the first diameter and the second diameter are substantially unchanged upon exposure to pressure greater than one atmosphere.

### BACKGROUND

This disclosure of the present application relates generally to fire suppression devices designed for vehicles, as well as with batteries. Such devices may include those integral to, or in tandem with, vehicle battery packs.

Many fire suppression devices are portable or semi-portable devices which are used to extinguish or control small fires prior to their expansion into larger, and more unwieldy fires. These devices typically consist of a pressure vessel which contains a fire suppression agent that can be discharged to extinguish a fire, and a siphon tube which has one end attached to a release valve and a second end submerged in a fire suppression agent. Discharge of the agent occurs when the release valve is opened, allowing the pressure within the pressure vessel to push the fire suppression agent through the siphon tube and out the release valve. Propulsion of the fire suppressant ceases once the level of the fire suppression agent falls below the level of the siphon tube.

There is significant need for alternate fire suppression devices given the structure of the siphon tube integral to fire suppression devices, as when the siphon tube is moved out of the fire suppressant and propulsion of the suppressant ceases. Siphon tubes are rigid and extend downward from the top to the bottom of the pressure chamber, effectively serving as a conduit for the fire suppressant. Given the inflexibility of the siphon tube, movement of the pressure chamber and the resulting movement of the fire suppression agent within the pressure chamber causes the end of the siphon tube to rise above the level of the fire suppressant. While this siphon tube structure is sufficient when the pressure chamber is positioned vertically, the effect of positioning the chamber in a horizontal orientation is that significantly less agent is able to be released given the position of the agent relative to the siphon tube.

### BRIEF SUMMARY

In at least one embodiment of the dip tube for a fire suppression device of the present disclosure, the dip tube is comprised of a first cylinder that has a first lumen with a first diameter, a second cylinder with a second lumen that has a second diameter, and a joining member. The joining member, in an exemplary embodiment, operably connects the first lumen with the second lumen to allow a substance to pass therethrough. The joining member allows movement of the second cylinder relative to the first cylinder. The first diameter and the second diameter are substantially unchanged upon exposure to pressure greater than one atmosphere.

In various embodiments of a dip tube of the present disclosure, the second cylinder may further comprise a sound dampener. Additionally, in at least one embodiment, the joining member may have a third lumen operably connecting the first lumen and second lumen.

In an exemplary embodiment of a fire suppression device of the present disclosure, the fire suppression device may comprise a container having an outlet and an embodiment of a dip tube as described herein positioned within the container.

In another exemplary embodiment of the present application, a fire suppression system may comprise a battery which is operable to supply power to operate a vehicle, and a fire suppression device positioned relative to the battery so that the fire suppression device can operate to extinguish a battery fire.

In an exemplary embodiment of a vehicle according to the present application, the vehicle comprises a battery that is operable to power the vehicle, and a fire suppression device positioned relative to the battery so that the fire suppression device can extinguish a battery fire.

In an exemplary embodiment of a method of fire suppression, the method comprises the steps of providing an embodiment of a fire suppression device as described herein, and operating the fire suppression device to propel a fire suppression substance through the outlet of the fire suppression device to suppress a fire. Various additional embodiments of the method may include having the fire suppression device further comprising a pressurized member, and triggering an actuator to release the contents of the pressurized member. In at least an additional embodiment, the first cylinder is substantially perpendicular to the force of gravity in the container.

### BRIEF DESCRIPTION OF THE DRAWINGS

Further advantages of the disclosure of the present application will become apparent upon reading the following detailed description in conjunction with the accompanying drawings, in which:

FIG. 1 shows a sectional view of an exemplary embodiment of a dip tube according to the present disclosure;

FIG. 2 shows a sectional view of an exemplary embodiment of a dip tube of FIG. 1, according to the present disclosure;

FIG. 3 shows a sectional view of an exemplary embodiment of a dip tube of FIG. 1, according to the present disclosure;

FIG. 4 shows a sectional view of an exemplary embodiment of a fire suppression device according to the present disclosure;

FIG. 5 shows a sectional view of an exemplary embodiment of a fire suppression system according to the present disclosure;

FIG. 6 shows a sectional view of an exemplary embodiment of a vehicle according to the present disclosure; and

FIG. 7 shows a flowchart according to an exemplary embodiment of the fire suppression method, according to the present disclosure.

### DETAILED DESCRIPTION

Reference will now be made to the embodiments illustrated in the drawings and specific language will be used to describe the same. It will nevertheless be understood that no limitation of scope is intended by the description of these embodiments.

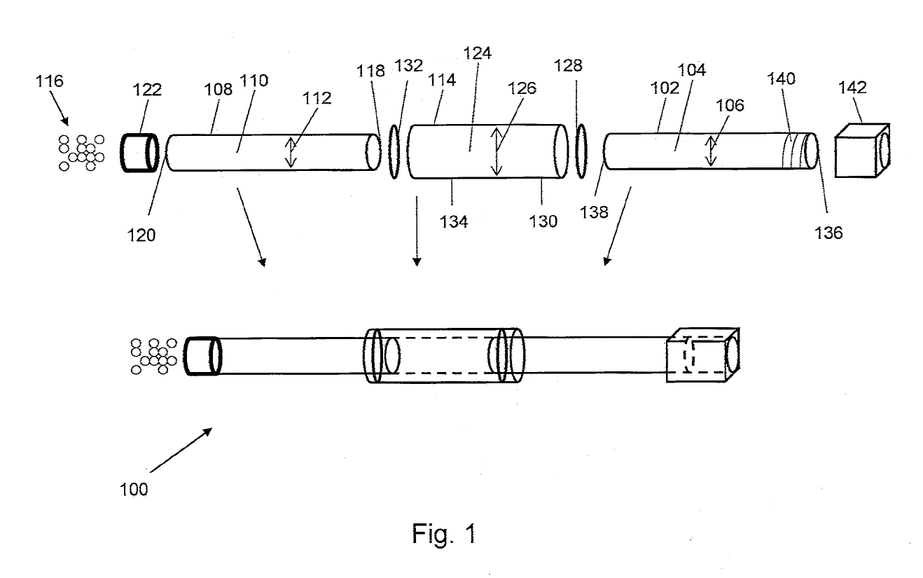

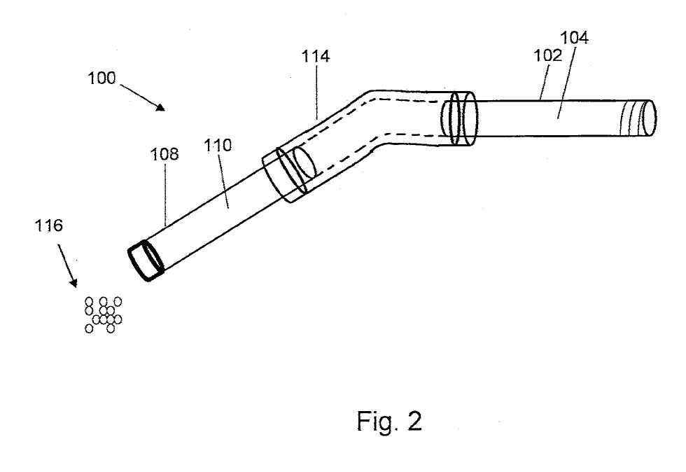

FIG. 1 shows at least one embodiment of the dip tube 100 of the disclosure of the present application. In an exemplary embodiment, dip tube 100 comprises a first cylinder 102 defining a first lumen 104 having a first diameter 106, a second cylinder 108 defining a second lumen 110 having a second diameter 112, and a joining member 114 operably connecting the first lumen 104 with the second lumen 110 to allow a substance 116 to pass therethrough. Joining member 114, in an exemplary embodiment, allows movement of the second cylinder 108 relative to the first cylinder 102. The first diameter 106 and the second diameter 112 are substantially unchanged upon exposure to pressure greater than one atmosphere. For purposes of this disclosure, one atmosphere will be equivalent to about 14.7 psi. In at least one embodiment, the weight of the second cylinder 108 is sufficient to overcome the rigidity of the joining member 114 and produce a bend in the joining member 114 as shown in FIG. 2. In an exemplary embodiment, the force of gravity acting on second cylinder 108 is sufficient to overcome the intrinsic stiffness of the joining member 114,

In at least one embodiment, second cylinder 108 of dip tube 100 comprises a first end 118 and a second end 120, with the second end 120 comprising a sound dampener 122. Sound dampener 122, in an exemplary embodiment, may be comprised of a sound deadening material which is operable to muffle the sound of the second cylinder 108 making contact with an additional surface, such as for example container 402. In at least one embodiment of sound dampener 122, the sound deadening material is selected from the group consisting of a rubber, a foam, silicone, or plastic.

In at least one embodiment of the dip tube 100, the joining member 114 is comprised of a chemically non-reactive material. The chemically non-reactive material, according to an embodiment, may is selected from the group consisting of silicone, poly(tetrafluoroethylene), glass, ceramic, fluropolymer, vinyl, or polyethylene, Further, the first cylinder 102 and the second cylinder 108, according to at least one embodiment, may is selected from the group consisting of aluminum, copper, brass, and plastic. Joining member 114 of dip tube 100, according to at least one embodiment, comprises a third lumen 124 having a third diameter 126, the third lumen 124 operably connecting the first lumen 104 and second lumen 110. In an exemplary embodiment, the third diameter 126 is substantially unchanged by exposure to pressure greater than one atmosphere.

In an exemplary embodiment, joining member 114 may be a tube shaped structure having at least one passage therethrough. Joining member 114, in at least one embodiment, may be operable to twist and/or bend while maintaining a fluid channel between first lumen 104 and second lumen 110. Attachment of joining member 114 to first cylinder 102 and second cylinder 108, according to at least one embodiment, may occur through a locking mechanism integral to joining member 114.

Dip tube 100, in at least one exemplary embodiment, may further comprise a first securing member 128, the first securing member 128 fixedly attaching a first portion 130 of the joining member 114 to the first cylinder 102. Optionally, dip tube 100 may further comprise a second securing member 132, the second securing member 132 fixedly attaching a second portion 134 of the joining member 114 to the second cylinder 108.

First securing member 128 and second securing member 132 may, in at least one embodiment, comprise a substantially inflexible tether material which constricts the movement of the first cylinder 102 second cylinder 108 in relation to the joining member 114. Exemplary embodiments of first securing member 128 or second securing member 132 include a clamping device or restraining clip.

In at least one embodiment of dip tube 100, as shown in FIG. 1, first cylinder 102 comprises a first end 136 and a second end 138, the first end 136 comprising an attachment portion 140 for attachment to a release member 142. In such an exemplary embodiment, dip tube 100 may be operable to allow passage of a substance 116 from the first lumen 104 to the release member 142.

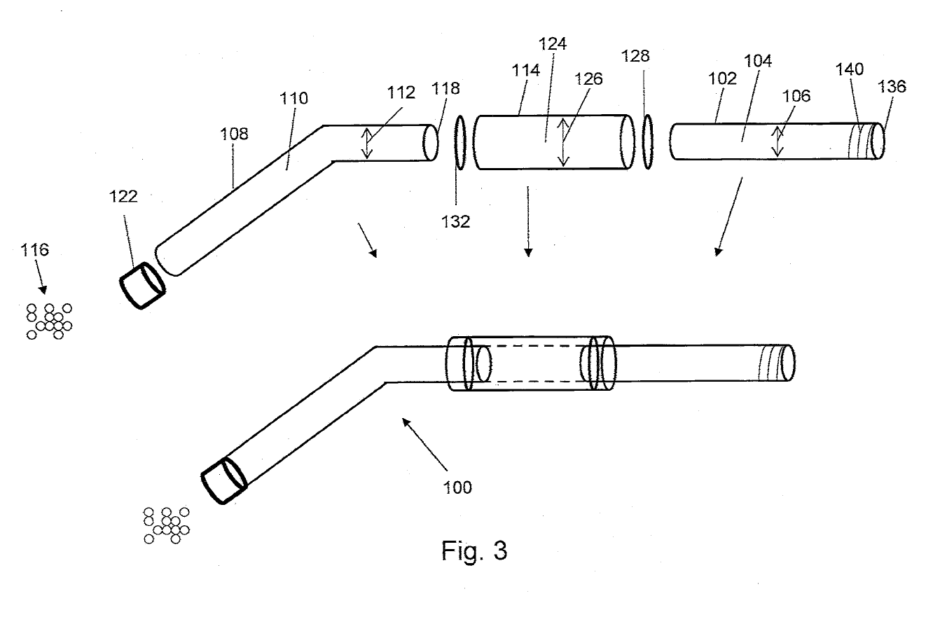

In at least one embodiment of dip tube 100, as depicted in FIG. 2, joining member 114 has a flexible characteristic, so as to allow the movement of the second cylinder 108 relative to the first cylinder 102. In a least another embodiment, second cylinder 108, as shown in FIG. 3, may include a bend to further facilitate the passage of substance 116 therethrough. The bend in second cylinder 108 may encompass bends of varying degrees dependant on the architecture of dip tube 100 and the surrounding environment. In at least one embodiment, the bend in second cylinder 108 may constitute a bend of up to 50 degrees relative to the position of the first cylinder 102.

Joining member 114, in at least one embodiment of dip tube 100 depicted in FIGS. 1-3, may be operable to allow the rotation of second cylinder 108. Rotation of the second cylinder 108 may encompass, for example, a rotation of 360° relative to the first cylinder 102. Additionally, in at least one embodiment, the weight of second cylinder 108 may be sufficient to rotate the second cylinder 108 relative to the force of gravity acting on dip tube 100. In a further embodiment, the weight of sound dampener 122 is sufficient to rotate the second cylinder 108 relative to the force of gravity acting on dip tube 100, In at least one embodiment, rotation of second cylinder 108 moves the second end 120 of the second cylinder in a significantly downward direction,

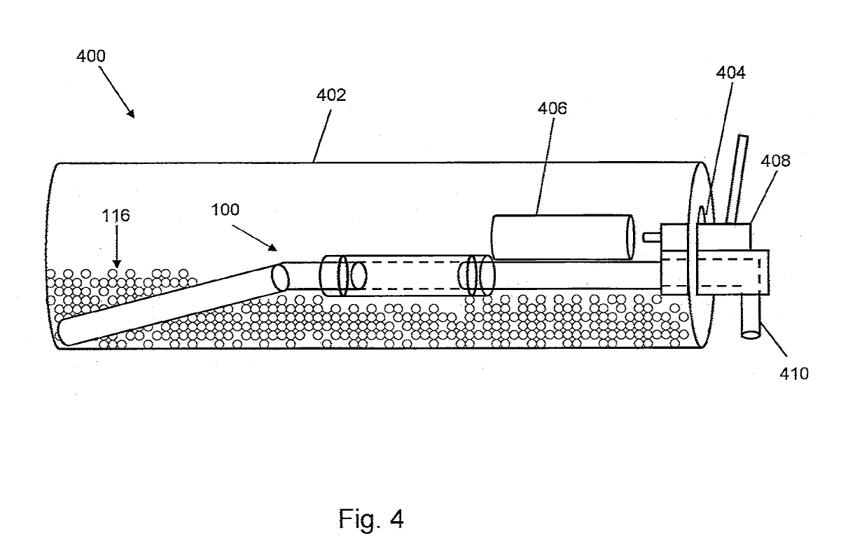

FIG. 4 shows at least embodiment of fire suppression device 400 of the disclosure of the present application. Fire suppression device 400, according to at least one embodiment, comprises a container 402 having an outlet 404. Container 400, as shown in FIG. 4, further comprises an embodiment of dip tube 100, as depicted in FIGS. 1-3, positioned within the container 402. Optionally, the pressure within container 402, according to an exemplary embodiment, is greater than one atmosphere.

Fire suppression device 400, according to at least one embodiment of the present disclosure, further comprises a substance 116 within the container 402, wherein the substance 116 comprises a material capable of extinguishing a fire, The substance 116, in at least one embodiment, may is selected from the group consisting of water, foam, dry powder, carbon dioxide, halon, a vaporizing liquid, or a wet chemical. The foam, according to at least one embodiment of the substance 116, may is selected from the group consisting of an aqueous film forming foam, an alcohol resistant aqueous film forming foam, a film forming fluroprotein, or a compressed air foam. The dry powder, according to at least one embodiment of the substance 116, may is selected from the group consisting of ammonium phosphate, sodium bicarbonate, potassium bicarobonate, or potassium chloride. The vaporizing liquid, according to at least one embodiment of substance 116, may is selected from the group consisting of carbontetrachloride and chlorobromomethane. Further, the wet chemical, according to at least one embodiment of substance 116, may is selected from the group consisting of potassium acetate, potassium carbonate, and potassium citrate.

Fire suppression device 400, according to an exemplary embodiment shown in FIG. 4, may further comprise a pressurized member 406 within the container 402 and an actuator 408 operably connected to the pressurized member 406, wherein the actuator 408 is operable to release contents of the pressurized member 406 within the container 402. Additionally, container 402, in at least one embodiment, may further comprise an expression nozzle 410 operably connected to the outlet 404. The expression nozzle 410, as shown in FIG. 4, is sized and shaped to permit passage of a substance 116 therethrough.

According to at least one embodiment of a fire suppression device 400 of the present disclosure, the fire suppression device 400 is operable to expel at least a portion of a substance 116 present within the container 402 through the outlet 404 when the first cylinder 102 is substantially perpendicular to the force of gravity within the container 402, The expelling characteristic of fire suppression device 400 according to at least one embodiment, is sufficient to expel at least about 50% to about 100% of the substance 116 through the outlet 404 when the first cylinder 102 is substantially perpendicular to the force of gravity within the container 402.

According to a least one embodiment, fire suppression device 400 comprises a container 402 that has an outlet 404, an expression nozzle 410 that is operably connected to the outlet 404, and an actuator 408 which is operable to allow the flow of a portion of a substance 116 through the expression nozzle 410. Optionally, the pressure within container 402, according to an exemplary embodiment, is greater than one atmosphere. Fire suppression device 400, in at least one embodiment, further comprises an embodiment of dip tube 100, as shown in FIGS. 1-3 and described herein, within the container 402. In at least this embodiment, dip tube 100 comprises a first cylinder 102 defining a first lumen 104 having a first diameter 106, the first cylinder 102 of the dip tube 100 operably coupled to the outlet of the container, a second cylinder 108 defining a second lumen 110 having a second diameter 112, and a joining member 114. In an exemplary embodiment, joining member 114 may operably connect the first lumen 104 with the second lumen 110 to allow a substance 116 to pass therethrough. Additionally, in at least one embodiment, the joining member 114 may allow movement of the second cylinder 108 relative to the first cylinder 102. Further, in at least one embodiment, the first diameter 106 and the second diameter 112 may be substantially unchanged upon exposure to pressure greater than one atmosphere.

In at least one embodiment of a fire suppression device 400, the fire suppression device 400 further comprises a pressurized member 406 within the container 402, wherein the actuator 408 is operable to release the contents of the pressurized member 406. Additionally, in at least this exemplary embodiment, the fire suppression device 400 further comprises a substance 116 within the container 402, the substance 116 comprising a material capable of extinguishing a fire. In at least one embodiment, the fire suppression device 400 is operable to expel a portion of the substance 116 through the outlet 404 when the first cylinder 102 is substantially perpendicular to the force of gravity.

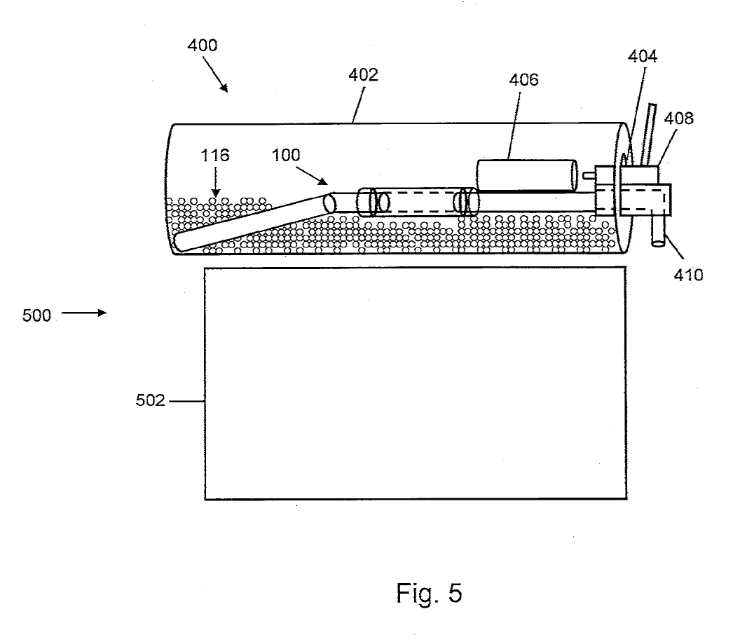

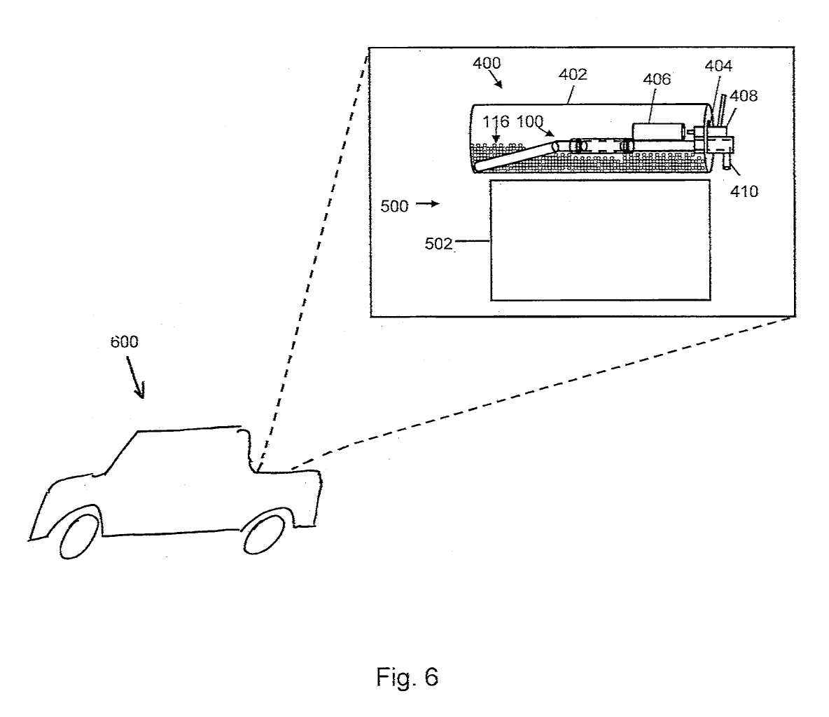

In at least one embodiment of the disclosure of the present application, and as depicted in FIG. 5, a fire suppression system 500 comprises a battery 502 operable to supply power to operate a vehicle, and an exemplary embodiment of a fire suppression device 400 of the present disclosure positioned relative to the battery 502 so that the fire suppression device 400 can operate to extinguish a battery fire. FIG. 6, according to at least one embodiment, shows vehicle 600 comprising a battery 502 operable to supply power to a vehicle, and a fire suppression device 400 positioned relative to the battery 502 so that the fire suppression device 400 can operate to extinguish a battery fire. Vehicle 600 according to an exemplary embodiment, may be any vehicle 600 used for transportation including cars, trucks, helicopters, plane, and ships. In at least one embodiment, fire suppression system 500 may also be mounted within an electronic device.

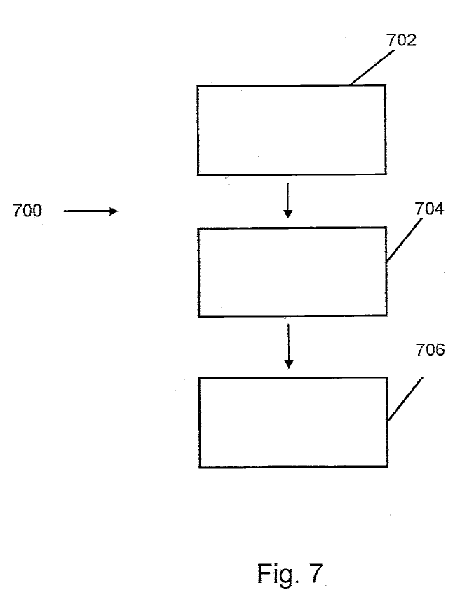

FIG. 7 depicts an exemplary method of fire suppression according to at least one embodiment of the present disclosure. Method 700, in at least one embodiment, comprises the steps of providing a fire suppression device 702, the step of operating the fire suppression device 704 to propel the substance 116 through the outlet 404 to suppress a fire, and the step of triggering an actuator 706 to release the contents of a pressurized member 406 of fire suppression device 400. In at least one embodiment of method 700, the first cylinder 102 of fire suppression device 400 is substantially perpendicular to the force of gravity.

### Example

In each analysis conducted, a standard 2.5 lb fire extinguisher bottle with standard dip tube was filled with 1.5 lbs of Novec™ fire suppressant agent and weighed. To test vertical discharge, a fire extinguisher bottle was positioned in the standard vertical position and discharged. Following discharge, the bottle was weighed and we determined that approximately 1.4 lbs of agent was released. To determine the effect of horizontal positioning on discharge capacity, the fire bottle with a standard dip tube was placed in a horizontal position and discharged and weighed yielding a total discharge of 0.8 lbs of agent. In determining the effect of horizontal positioning on discharge capacity using the dip tube described herein, a fire bottle mounted in a horizontal position and containing the dip tube depicted in FIG. 3 was prepared and discharged yielding a 1.2 lbs total discharge.

While various embodiments of dip tubes and fire suppression devices have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. For example, any number of dip tubes 100 referenced herein may have one or more features/components of another dip tube 100 referenced within the present disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written, Such sequences may be varied and still remain within the spirit and scope of the present disclosure,

We claim:

1. A dip tube for a fire suppression device, the dip tube comprising:
a first cylinder defining a first lumen having a first diameter;
a second cylinder defining a second lumen having a second diameter; and
a joining member operably connecting the first lumen with the second lumen to allow a material capable of extinguishing a fire to pass therethrough, the joining member allowing movement of the second cylinder relative to the first cylinder;
wherein the first diameter and the second diameter are substantially unchanged upon exposure to pressure greater than one atmosphere.

2. The dip tube of claim 1, wherein the second cylinder comprises a first end and a second end, the second end comprising a sound dampener.

3. The dip tube of claim 1, wherein the joining member is comprised of a chemically non-reactive material,

4. The dip tube of claim 1, wherein the chemically non-reactive material is selected from the group consisting of silicone, poly(tetrafluoroethylene), glass, ceramic, fluropolymer, vinyl, or polyethylene.

5. The dip tube of claim 1, wherein the first cylinder and the second cylinder is selected from the group consisting of aluminum, copper, brass, and plastic.

6. The dip tube of claim 1, wherein the joining member comprises a third lumen having a third diameter, the third lumen operably connecting the first lumen and second lumen.

7. The dip tube of claim 6, wherein the third diameter is substantially unchanged by exposure to pressure greater than one atmosphere.

8. The dip tube of claim 1, further comprising a first securing member, the first securing member fixedly attaching a first portion of the joining member to the first cylinder.

9. The dip tube of claim 8, further comprising a second securing member, the second securing member fixedly attaching a second portion of the joining member to the second cylinder.

10. The dip tube of claim 1, wherein the first cylinder comprises a first end and a second end, the first end comprising an attachment portion for attachment to a release member, and wherein the dip tube is operable to allow passage of the material capable of extinguishing a fire from the first lumen to the release member.

11. A fire suppression device comprising;
a container having an outlet; and
a dip tube positioned within the container, the dip tube comprising:
a first cylinder defining a first lumen having a first diameter; the first cylinder of the dip tube operably coupled to the outlet of the container;
a second cylinder defining a second lumen having a second diameter; and
a joining member operably connecting the first lumen with the second lumen to allow a substance to pass therethrough, the joining member allowing movement of the second cylinder relative to the first cylinder;
wherein the first diameter and the second diameter are substantially unchanged upon exposure to pressure greater than one atmosphere.

12. The fire suppression device of claim 11, further comprising a substance within the container, wherein the substance comprises a material capable of extinguishing a fire.

13. The fire suppression device of claim 11, wherein the substance is selected from the group consisting of water, foam, dry powder, carbon dioxide, halon, a vaporizing liquid, or a wet chemical.

14. The fire suppression device of claim 13, wherein the foam is selected from the group consisting of an aqueous film forming foam, an alcohol resistant aqueous film forming foam, a film forming fluroprotein, or a compressed air foam.

15. The fire suppression device of claim 13, wherein the dry powder is selected from the group consisting of ammonium phosphate, sodium bicarbonate, potassium bicarobonate, or potassium chloride.

16. The fire suppression device of claim 13, wherein the vaporizing liquid is selected from the group consisting of carbontetrachloride and chlorobromomethane.

17. The fire suppression device of claim 13, wherein the wet chemical is selected from the group consisting of potassium acetate, potassium carbonate, and potassium citrate.

18. The fire suppression device of claim 11, further comprising a pressurized member within the container and an actuator operably connected to the pressurized member, wherein the actuator is operable to release contents of the pressurized member within the container.

19. The fire suppression device of claim 18, wherein the container further comprises an expression nozzle operably connected to the outlet, the expression nozzle sized and shaped to permit passage of a substance therethrough.

20. The fire suppression device of claim 11, wherein the device is operable to expel at least a. portion of a substance present within the container through the outlet when the first cylinder is substantially perpendicular to the force of gravity within the container.

21. The fire suppression device of claim 20, wherein the device is operable to expel at least about 50% to about 100% of the substance through the outlet when the first cylinder is substantially perpendicular to the force of gravity within the container,

22. A fire suppression device comprising:
a container comprising:
an outlet;
an expression nozzle, the expression nozzle operably connected to the outlet; and
an actuator, the actuator operable to allow the flow of a portion of a substance through the expression nozzle;
a dip tube within the container, the dip tube comprising:
a first cylinder defining a first lumen having a first diameter, the first cylinder of the dip tube is operably coupled to the outlet of the container;
a second cylinder defining a second lumen having a second diameter; and
a joining member operably connecting the first lumen with the second lumen to allow a substance to pass therethrough, the joining member allowing movement of the second cylinder relative to the first cylinder;
wherein the first diameter and the second diameter are substantially unchanged upon exposure to pressure greater than one atmosphere.

23. The fire suppression device of claim 22, further comprising a pressurized member within the container, wherein the actuator is operable to release the contents of the pressurized member, and
a substance within the container, the substance comprising a material capable of extinguishing a fire,

24. The fire suppression device of claim 23, wherein the system is operable to expel a portion of the substance through the outlet when the first cylinder is substantially perpendicular to a force of gravity.

25. A fire suppression system comprising:
a battery operable to supply power to operate a vehicle; and
a fire suppression device positioned relative to the battery so that the fire suppression device can operate to extinguish a battery fire, the fire expression device comprising:
a container having an outlet;
a dip tube within the container, the dip tube comprising:
a first cylinder defining a first lumen having a first diameter;
a second cylinder defining a second lumen having a second diameter; and
a joining member operably connecting the first lumen with the second lumen to allow a substance to pass therethrough, the joining member allowing movement of the second cylinder relative to the first cylinder;
wherein the first diameter and the second diameter are substantially unchanged upon exposure to pressure greater than one atmosphere; and
a substance within the container, the substance comprising a material capable of extinguishing a fire;
wherein the first cylinder of the dip tube is operably coupled to the outlet of the container.

26. A vehicle comprising:
a battery operable to supply power to a vehicle; and
a fire suppression device positioned relative to the battery so that the fire suppression device can operate to extinguish a battery fire, the fire suppression device comprising:
a container having an outlet;
a dip tube within the container, the dip tube comprising:
a first cylinder defining a first lumen having a first diameter, the first cylinder operably coupled to the outlet of the container;
a second cylinder defining a second lumen having a second diameter;
a joining member operably connecting the first lumen with the second lumen to allow a substance to pass therethrough, the joining member allows movement of the second cylinder relative to the first cylinder;
wherein the first diameter and the second diameter are substantially unchanged upon exposure to pressure greater than one atmosphere; and
a substance within the container, the substance comprising a material capable of extinguishing a fire.

27. A method of fire suppression, the method comprising the steps of:
providing a fire suppression device comprising:
a container having an outlet;
a dip tube within the container, the dip tube comprising:
a first cylinder defining a first lumen having a first diameter, the first cylinder operably coupled to the outlet of the container;
a second cylinder defining a second lumen having a second diameter;
a joining member operably connecting the first lumen with the second lumen to allow a substance to pass therethrough; the joining member allows movement of the second cylinder relative to the first cylinder;
wherein the first diameter and the second diameter are substantially unchanged upon exposure to pressure greater than one atmosphere; and
a substance within the container, the substance comprising a material capable of extinguishing a fire;
operating the fire suppression device to propel the substance through the outlet to suppress a fire.

28. The method of claim 27, further comprising the step of triggering an actuator, the actuator operable to release the contents of a pressurized member present within the container.

29. The method of claim 27, wherein the first cylinder is substantially perpendicular to a force of gravity within the container.
